(19) United States
(12) Patent Application Publication
(10) Pub. No.: US 2024/0012175 A1
(43) Pub. Date: Jan. 11, 2024

(54) APPARATUS AND METHOD FOR CALCULATING SENSIBLE TEMPERATURE IN CONSIDERATION OF OUTDOOR GROUND HEATING AND HEATWAVE WARNING APPARATUS AND METHOD BASED ON SENSIBLE TEMPERATURE IN CONSIDERATION OF OUTDOOR GROUND HEATING

(71) Applicant: National Institute of Meteorological Sciences, Seogwipo-si (KR)

(72) Inventors: Hae Min KIM, Seogwipo-si (KR); Kyu Rang KIM, Icheon-si (KR); Ju Young SHIN, Seongwipo-si (KR)

(73) Assignee: National Institute of Meteorological Sciences, Seogwipo-si (KR)

(21) Appl. No.: 18/348,499

(22) Filed: Jul. 7, 2023

(30) Foreign Application Priority Data
Jul. 8, 2022 (KR) 10-2022-0084428

(51) Int. Cl. G01W 1/10; G06F 17/18; G06Q 50/26

(52) U.S. Cl. CPC G01W 1/10; G06F 17/18; G06Q 50/26; G01W 2201/00

(57) ABSTRACT

Provided are an apparatus and method for calculating a sensible temperature in consideration of outdoor ground heating and a heatwave warning apparatus and method based on a sensible temperature in consideration of outdoor ground heating. The method of calculating a sensible temperature in consideration of outdoor ground heating includes classifying data which includes a globe temperature, an atmospheric temperature, a relative humidity, and a ground surface temperature and is observed by an automated synoptic observing system (ASOS) for a certain period of time, as precipitation data and non-precipitation data according to whether there is precipitation, clustering the non-precipitation data into K clusters, and deriving K+1 sensible temperature calculation formulae by performing regression analysis on the K clusters and the precipitation data.

### CROSS-REFERENCE TO RELATED APPLICATION

This application claims priority to and the benefit of Korean Patent Application No. 10-2022-0084428, filed on Jul. 8, 2022, the disclosure of which is incorporated herein by reference in its entirety.

### BACKGROUND

### 1. Field of the Invention

The present disclosure relates to an apparatus and method for calculating a sensible temperature in consideration of outdoor ground heating. More specifically, the present disclosure relates to an apparatus and method for calculating a sensible temperature in consideration of outdoor ground heating which may improve an existing sensible temperature calculation formula in consideration of outdoor ground heating and use the improved sensible temperature calculation formula to provide appropriate sensible temperature information to a participant in an outdoor activity who is affected by ground heating and improve the accuracy of heatwave warnings.

### 2. Discussion of Related Art

Heatwaves are a natural disaster that may cause massive casualties. For this reason, countries around the world run heatwave warning systems to prevent damage from heatwaves. A heatwave diagnosis index which is most frequently used in the heatwave warning systems is a daily maximum temperature. The Korea Meteorological Administration (KMA) has also issued heatwave warnings based on the daily maximum temperature. However, in the atmospheric temperature, the solar radiation which directly touches the human body, and atmospheric humidity related to the human body's perspiration mechanism are not taken into consideration.

To solve this problem, the international organization for standardization (ISO) has adopted the wet-bulb globe temperature (WBGT), which reflects both solar radiation and atmospheric humidity, as a heat stress indicator, and proposed the WBGT as a standard for regulating activities in high-temperature environments in the industrial, military, and sports fields.

A WBGT value is calculated with a wet-bulb temperature Tw (° C.), a globe temperature Tg (° C.), and an atmospheric temperature Ta (° C.). Specifically, the prototype WBGT model is represented by the equation WBGT=0.7 Tw+0.2 Tg+0.1 Ta. In this way, calculating a WBGT value requires a globe temperature which is not a regular observation element. However, it is not easy to obtain a globe temperature observation value due to the small number of globe temperature observation stations in Korea.

To address this, KMA has developed WBGT estimation models (the KMA2006 model and the KMA2016 model) for estimating a WBGT value using regular observation elements.

A globe temperature estimation model TgKMA2006 was developed by performing linear regression analysis on globe temperatures, atmospheric temperatures, relative humidities (RH, %), wind speeds (WS, ms⁻¹), time-cumulative solar radiation (Slr, MJm⁻²h⁻¹) observed at the point of an automated synoptic observing system (ASOS) of KMA in Seoul (#108) from Sep. 26, 2006, to Jan. 31, 2007, and then applied to the prototype WBGT model to obtain the KMA2006 model.

With the KMA2016 model, it is possible to estimate a WBGT value using an atmospheric temperature and a relative humidity without solar radiation (Slr) data. The KMA2016 model estimates summer (from May to September) WBGT values. An atmospheric temperature obtained by adding 3.0° C. to an estimated WBGT value is also referred to as a “sensible temperature,” and a heatwave warning is issued on the basis of sensible temperatures.

However, an existing sensible temperature calculation formula has a significant systemic error which leads to frequent heatwave warnings, and thus it is difficult to arouse people's attention. In addition, participants in outdoor activities who are affected by ground heating are not taken into consideration.

### SUMMARY OF THE INVENTION

The present disclosure is directed to providing an apparatus and method for calculating a sensible temperature in consideration of outdoor ground heating which may reduce a systemic error and consider participants in outdoor activities who are affected by ground heating.

Technical problems to be achieved by the present disclosure are not limited to that described above, and other technical problems which have not been described will be clearly understood by those of ordinary skill in the art from the following description.

According to an aspect of the present disclosure, there is provided a method of calculating a sensible temperature in consideration of outdoor ground heating, the method including classifying data which includes a globe temperature, an atmospheric temperature, a relative humidity, and a ground surface temperature and is observed by an automated synoptic observing system (ASOS) for a certain period of time, as precipitation data and non-precipitation data according to whether there is precipitation, clustering the non-precipitation data into K clusters, and deriving K+1 sensible temperature calculation formulae by performing regression analysis on the K clusters and the precipitation data.

According to another aspect of the present disclosure, there is provided an apparatus for calculating a sensible temperature in consideration of outdoor ground heating, the apparatus including a classifier configured to classify data which includes a globe temperature, an atmospheric temperature, a relative humidity, and a ground surface temperature and is observed by an ASOS for a certain period of time, as precipitation data and non-precipitation data according to whether there is precipitation, a clustering part configured to cluster the non-precipitation data into K clusters, and an analysis part configured to derive K+1 sensible temperature calculation formulae by performing regression analysis on the K clusters and the precipitation data.

Other details of exemplary embodiments are included in the detailed description and accompanying drawings.

### BRIEF DESCRIPTION OF THE DRAWINGS

The above and other aspects of the present disclosure will become more apparent to those of ordinary skill in the art by describing exemplary embodiments thereof in detail with reference to the accompanying drawings, in which:

FIG. 1 is a set of diagrams illustrating distributions of meteorological variables according to whether there is precipitation in a day;

FIG. 2 is a set of diagrams in which graphs illustrating relationships between a sensible temperature based on an existing sensible temperature calculation formula, a sensible temperature based on an improved sensible temperature calculation formula, and a sensible temperature based on an observed value are shown separately according to clusters and whether there is precipitation;

FIG. 3 is a set of diagrams in which systemic errors of an existing sensible temperature calculation formula and systemic errors of an improved sensible temperature calculation formula are comparatively illustrated;

FIG. 4 is a table comparatively showing performance of an existing model and an improved model with regard to non-precipitation data;

FIG. 5 is a table comparatively showing performance of an existing model and an improved model with regard to precipitation data;

FIG. 6 is a confusion matrix showing prediction results of an existing model and prediction results of an improved model;

FIG. 7 is a table comparatively showing evaluation results of an existing model and an improved model;

FIG. 8 is a block diagram of an apparatus for calculating a sensible temperature in consideration of outdoor ground heating according to an exemplary embodiment of the present disclosure;

FIG. 9 is a flowchart illustrating a method of calculating a sensible temperature in consideration of outdoor ground heating according to an exemplary embodiment of the present disclosure;

FIG. 10 is a block diagram of a heatwave warning apparatus based on a sensible temperature according to an exemplary embodiment of the present disclosure; and

FIG. 11 is a flowchart illustrating a heatwave warning method based on a sensible temperature according to an exemplary embodiment of the present disclosure.

### DETAILED DESCRIPTION OF EXEMPLARY EMBODIMENTS

The advantages and features of the present disclosure and methods of achieving the same will become apparent from exemplary embodiments described in detail below with reference to the accompanying drawings. However, the present disclosure is not limited to the exemplary embodiments disclosed below and may be implemented in various different forms. The exemplary embodiments are provided only to make the present disclosure complete and fully convey the scope of the invention to those skilled in the technical field to which the present disclosure pertains. The present disclosure is only defined by the scope of the claims.

Unless otherwise defined, all terms (including technical and scientific terms) used herein are used with the same meanings as commonly understood by those skilled in the technical field to which the present invention pertains. Also, terms defined in commonly used dictionaries are not interpreted with ideal or excessively formal meanings unless explicitly defined herein.

Terminology used herein is for the purpose of describing the exemplary embodiments and is not intended to limit the present disclosure. In this specification, the singular forms include the plural forms unless the context clearly indicates otherwise. As used herein, the terms “comprises” and/or “comprising” do not preclude the presence or addition of one or more components other than those stated.

Hereinafter, apparatus and method for calculating sensible temperature in consideration of outdoor ground heating and a heatwave warning apparatus and method based on a sensible temperature in consideration of outdoor ground heating according to exemplary embodiments of the present disclosure will be described with reference to the accompanying drawings. In the drawings, the same reference numerals refer to the same components.

The KMA2016 model developed by the Korea Meteorological Administration (KMA) estimates a sensible temperature using an atmospheric temperature and a relative humidity without solar radiation (Slr) data. The KMA2016 model provides a summer sensible temperature, and a summer sensible temperature calculation formula is given as Equation 1.

$${WBGT}_{KMA 2016} = - 0.2442 + 0.553 \; 99 Tw + 0.45535 Ta - 0.00 \; 22 {Tw}^{2} + 0.00278 TwTa + 3.5 \qquad [ Equation 1 ]$$

$$Tw = Ta {tan}^{- 1} [ 0.151977 {( R H + 8.313659 )}^{\frac{1}{2}} ] + {tan}^{- 1} ( Ta + RH ) - {tan}^{- 1} ( R H - 1.67633 ) + 0.003918 \; 38 {RH}^{\frac{3}{2}} {tan}^{- 1} ( 0.2 \; 3101 RH ) - 4.686035$$

In Equation 1, Ta represents a dry-bulb temperature, that is, an atmospheric temperature (° C.). Tw represents a wet-bulb temperature, and RH represents a relative humidity (%). In Equation 1, the constant “3.5” may be replaced with another value. For example, “3.5” may be replaced with “3.0.” In the following description, Equation 1 in which the constant “3.5” is replaced with “3.0” is called “KMA2016 model.” As shown in Equation 1, the KMA2016 model calculates a sensible temperature using an atmospheric temperature and a relative humidity. However, the sensible temperature (hereinafter “WBGT_KMA2016”) calculated in this way differs from a sensible temperature (hereinafter “WBGT_OBS”) calculated on the basis of observed values of a wet-bulb temperature, a globe temperature, and an atmospheric temperature.

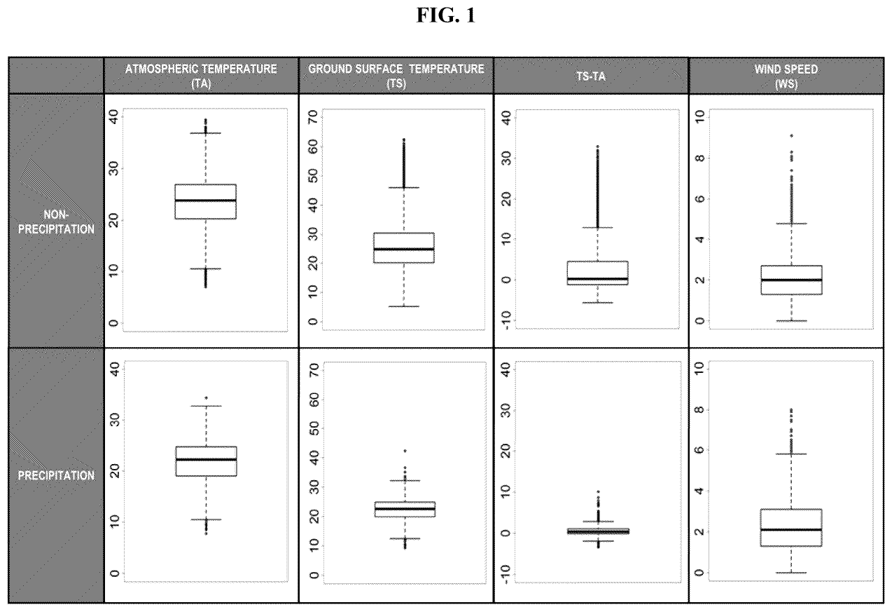

To reduce such a systemic error, the present disclosure uses a sensible temperature calculation formula which includes not only an atmospheric temperature and a relative humidity but also a ground surface temperature as variables. The reason that a ground surface temperature is added to the sensible temperature calculation formula as a variable will be described in detail with reference to FIG. 1.

FIG. 1 is a set of diagrams illustrating distributions of meteorological variables according to whether there is precipitation in a day.

Referring to box plots for each meteorological variable in FIG. 1, the distributions of an atmospheric temperature TA and a wind speed WS do not significantly vary depending on whether there is precipitation. On the other hand, the distribution of a ground surface temperature TS significantly varies depending on whether there is precipitation. Also, the distribution of a difference (TS−TA) between the ground surface temperature TS and the atmospheric temperature TA significantly varies depending on whether there is precipitation. In other words, a systemic error according to the existing sensible temperature calculation formula may be construed as being caused by the difference (TS−TA) between the ground surface temperature TS and the atmospheric temperature TA. Therefore, when the existing sensible temperature calculation formula is improved by adding a variable (TS−TA) related to the ground surface temperature to the existing sensible temperature calculation formula in which an atmospheric temperature and a relative humidity are included as variables, it is possible to reduce a systemic error using the improved sensible temperature calculation formula.

A process of deriving the improved sensible temperature calculation formula may be given as Equation 2.

[Equation 2]

WBGT_KMA2016=f(TA,RH) (1)

WBGT_OBS=f(TA,RH,TG) (2)

Error_KMA2016=WBGT_KMA2016−WBGT_OBS (3)

WBGT_OBS=WBGT_KMA2016−Error_KMA2016 (4)

WBGT_OBS=WBGT_KMA2016−f(TS−TA) (5)

WBGT_KMA2022=WBGT_KMA2016−f(TS−TA)=f(TS,TA,RH) (6)

In (1) of Equation 2, WBGT_KMA2016 is a sensible temperature calculation formula based on the existing KMA2016 model. WBGT_KMA2016 is represented as a function having an atmospheric temperature and a relative humidity as variables. In (2), WBGT_OBS is a sensible temperature calculation formula based on an observed value, that is, the prototype WBGT model. WBGT_OBS is represented as a function having an atmospheric temperature, a relative humidity, and a globe temperature as variables. In (3), Error_KMA2016 is a systemic error and defined as a value obtained by subtracting WBGT_OBS from WBGT_KMA2016. (4) may be obtained by rearranging (3). With reference to FIG. 1, it has been described above that a systemic error is caused by the difference (TS−TA) between the ground surface temperature TS and the atmospheric temperature TA. Therefore, when the systemic error in (4) is replaced with the difference (TS−TA) between the ground surface temperature TS and the atmospheric temperature TA, (5) may be obtained. Assuming that WBGT_OBS in (5) is equal to WBGT_KMA2022 which is an improved sensible temperature calculation formula, (6) may be obtained. Assuming that WBGT_KMA2016 in (6) is a constant, a linear relationship may be observed between WBGT_KMA2022 and f(TS−TA). Accordingly, when linear regression analysis is performed on meteorological data collected for a certain period of time using an artificial intelligence model, the linear relationship between variables, that is, the linear relationship between WBGT_KMA2022 and f(TS−TA), may be specifically modeled. In other words, this may be understood as a process of modifying the linear equation using given data. When the linear regression analysis is completed, a weight applied to f(TS−TA) and/or a constant added to the equation is determined. Regression analysis according to an exemplary embodiment of the present disclosure will be described in further detail below.

According to an exemplary embodiment of the present disclosure, automated synoptic observing system (ASOS) data (e.g., globe temperatures, atmospheric temperatures, relative humidities, and ground surface humidities) of Seoul Observatory from May 1, 2017, to Sep. 30, 2021, may be used in regression analysis. Specifically, when an extreme value of WBGT_OBS based on globe temperatures appears several times in a day, meteorological variable data (an atmospheric temperature, a relative humidity, and a ground surface temperature) at the time at which an extreme value of WBGT_OBS first appears may be used.

According to an exemplary embodiment of the present disclosure, the data may be classified as non-precipitation data and precipitation data. There are a small number of pieces of precipitation data, and thus precipitation data does not require grouping. On the other hand, there are a large number of pieces of non-precipitation data, and thus non-precipitation data may be clustered into a certain number of clusters. As a grouping method, one of the K-means clustering algorithm, mean shift, the Gaussian mixture model (GMM), and density-based spatial clustering of application with noise (DBSCAN) may be used. The case of using the K-means clustering algorithm will be described below as an exemplary embodiment.

The K-means clustering algorithm is a kind of unsupervised learning among types of machine learning. According to the K-means clustering algorithm, data having similar features is grouped into K clusters. A process of clustering data using the K-mean clustering algorithm includes five operations. Specifically, the process includes a first operation of setting a number K of clusters, a second operation of setting the initial center (i.e., centroid) of each cluster, a third operation of assigning data to a cluster at the closest initial centroid, a fourth operation of resetting the centroid of each cluster to the most central (average) point of data belonging to the cluster when cluster assignment for all data is completed, and a fifth operation of reassigning data to a cluster at the closest centroid. Here, the fourth operation and the fifth operation are repeated until no centroid is changed.

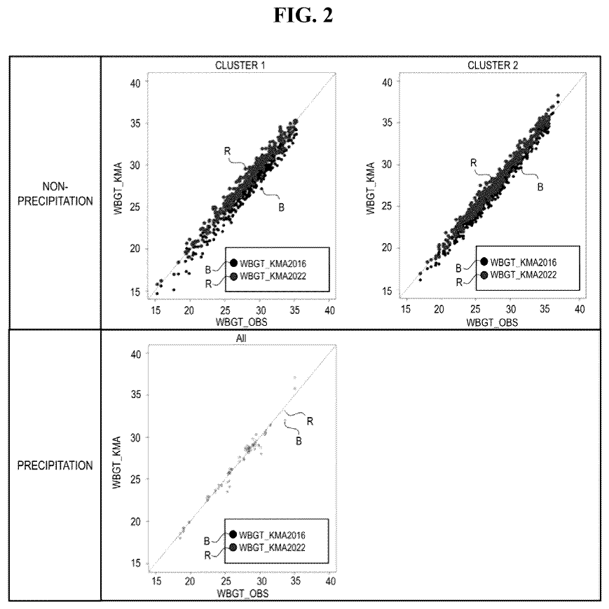

In the first operation, the number K of clusters may be determined by a person or through a mathematical method. Examples of the mathematical method may be a rule of thumb, a silhouette method, an elbow method, an information criterion approach, an information theoretic approach, and a consensus-based approach. As a result of using one of the foregoing methods, the number K of clusters may be determined to be two. Since K=2, the non-precipitation data may be grouped into a first cluster (see ‘CLUSTER 1’ in FIG. 2) and a second cluster (see ‘ CLUSTER 2’ in FIG. 2).

Subsequently, linear regression analysis may be separately performed on the first cluster of the non-precipitation data, the second cluster of the non-precipitation data, and the precipitation data. When the linear regression analysis on the first cluster of the non-precipitation data, the second cluster of the non-precipitation data, and the precipitation data is completed, three improved sensible temperature calculation formulae can be obtained. Hereinafter, the sensible temperature calculation formula acquired from the first cluster of the non-precipitation data is referred to as a “first sensible temperature calculation formula.” The sensible temperature calculation formula acquired from the second cluster of the non-precipitation data is referred to as a “second sensible temperature calculation formula.” Also, the sensible temperature calculation formula acquired from the precipitation data is referred to as a “third sensible temperature calculation formula.” The first, second, and third sensible temperature calculation formulae are given as Equations 3, 4, and 5, respectively.

WBGT_KMA2022=WBGT_KMA2016−0.00426718(TS−TA)−0.8904166 [Equation 3]

WBGT_KMA2022=WBGT_KMA2016−0.1543626(TS−TA)−0.2691554 [Equation 4]

WBGT_KMA2022=WBGT_KMA2016−0.2052482(TS−TA)+0.3239305 [Equation 5]

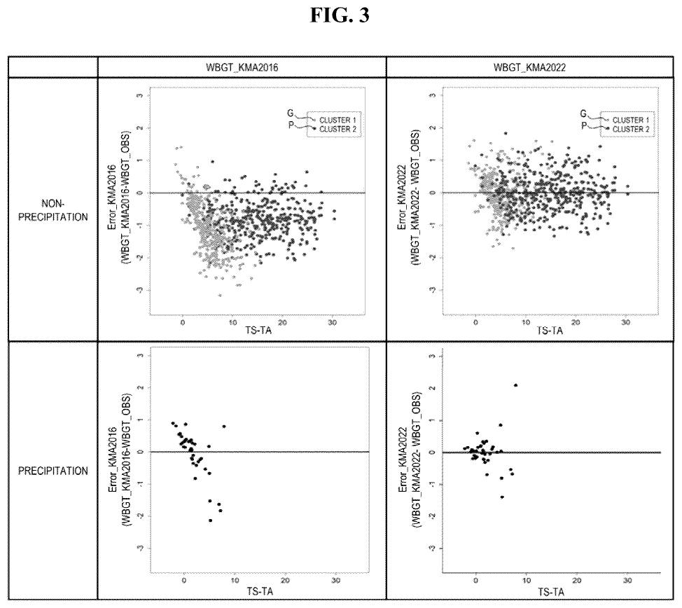

Referring to Equations 3 to 5, all the first to third sensible temperature calculation formulae have different weights applied to the difference (TS−TA) between the ground surface temperature TS and the atmospheric temperature TA and different constants applied thereto. Sensible temperatures based on the first to third sensible temperature calculation formulae are improved compared to that based on the existing sensible temperature calculation formula. Improvements of the first to third sensible temperature calculation formulae will be described in further detail below with reference to FIGS. 2 and 3.

FIG. 2 is a set of diagrams in which graphs illustrating relationships between a sensible temperature based on an existing sensible temperature calculation formula, a sensible temperature based on an improved sensible temperature calculation formula, and a sensible temperature based on an observed value are shown separately according to clusters and whether there is precipitation.

In the graphs shown in FIG. 2, the horizontal axes represent sensible temperatures WBGT_OBS based on observed values. The vertical axes represent sensible temperatures based on the existing sensible temperature calculation formula WBGT_KMA2016 or sensible temperatures based on the improved sensible temperature calculation formula WBGT_KMA2022. Meanwhile, in each graph, black points B represent sensible temperatures based on the existing sensible temperature calculation formula WBGT_KMA2016, and red points R represent sensible temperatures based on the improved sensible temperature calculation formula WBGT_KMA2022.

Referring to the graph related to the first cluster of the non-precipitation data, the graph related to the second cluster of the non-precipitation data, and the graph related to the precipitation data in FIG. 2, red points R are closer to the diagonal than black points B in each graph. This means that sensible temperatures based on the improved sensible temperature calculation formula are closer to the sensible temperatures based on observed values than sensible temperatures based on the existing sensible temperature calculation formula. In other words, when regression analysis data is classified by whether there is precipitation, non-precipitation data is clustered, and then different sensible temperature calculation formulae are applied according to a classification criterion and clusters, a more accurate sensible temperature can be obtained compared to the case of using one sensible temperature calculation formula.

FIG. 3 is a set of graphs separately showing systemic errors of an existing sensible temperature calculation formula and systemic errors of an improved sensible temperature calculation formula according to whether there is precipitation.

In the graphs shown in FIG. 3, the horizontal axes represent observed values of the difference (TS−TA) between the ground surface temperature TS and the atmospheric temperature TA. The vertical axes represent systemic errors Error_KMA2016 of the existing sensible temperature calculation formula or systemic errors Error_KMA2022 of the improved sensible temperature calculation formula. Meanwhile, in the graphs related to non-precipitation data, green points represent data belonging to the first cluster, and purple points represent data belonging to the second cluster.

Referring to the two graphs related to the non-precipitation data in FIG. 3, most systemic errors Error_KMA2016 of the existing sensible temperature calculation formula WBGT_KMA2016 are distributed below the horizontal line. In particular, systemic errors of data belonging to the first cluster are concentrated in an inverse diagonal shape. On the other hand, overall systemic errors Error_KMA2022 of the improved sensible temperature calculation formula WBGT_KMA2022 are evenly distributed above and below the horizontal line.

Referring to the two graphs related to the precipitation data in FIG. 3, a relatively large number of systemic errors Error_KMA2016 of the existing sensible temperature calculation formula WBGT_KMA2016 are distributed far from the horizontal line. On the other hand, a relatively large number of systemic errors Error_KMA2022 of the improved sensible temperature calculation formula WBGT_KMA2022 are distributed close to the horizontal line.

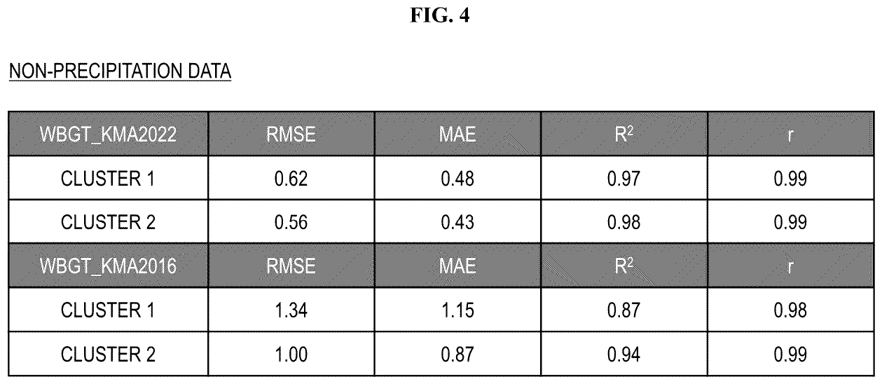

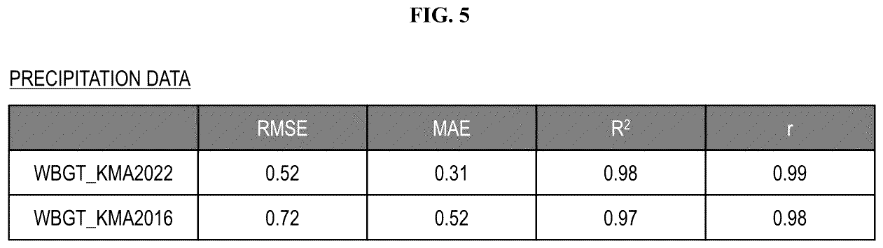

Now, performance of a model employing the existing sensible temperature calculation formula WBGT_KMA2016 (hereinafter, “existing model”) and a model employing the improved sensible temperature calculation WBGT_KMA2022 (hereinafter, “improved model”) will be comparatively described with reference to FIGS. 4 and 5.

As performance evaluation indicators for comparing the existing model with the improved model, a root mean square error (RMSE), a mean absolute error (MAE), a coefficient of determination (R squared score, R²), and a Pearson correlation coefficient (r) may be used.

The RMSE is obtained by applying a root to a mean square error (MSE). The MSE is the average of squares of values obtained by subtracting observed values from prediction values. The MSE may be obtained by dividing a residual sum of squares (RSS) by the number of pieces of corresponding data.

The MAE is the average of absolute values of values obtained by subtracting observed values from prediction values. The MAE is not a squared value and thus has the same unit as existing data. Accordingly, it is possible to easily recognize an error according to an increase or decrease in the regression coefficient.

The coefficient of determination (R²) is an indicator for measuring performance of accuracy in data prediction by calculating the variance of prediction values with respect to the variance of actually observed values. The coefficient of determination (R²) is represented as a value of 0 to 1, and when the coefficient of determination (R²) is closer to one, a corresponding model may be evaluated as a model having 100% explanatory power. The coefficient of determination (R²) may be calculated by dividing the sum of squares of errors by the sum of squares of deviations, and subtracting the obtained value from 1. When there is a closer correlation between two variables, the coefficient of determination (R²) has a value closer to one.

The Pearson correlation coefficient (r) is a measure representing the correlation between two variables. The Pearson correlation coefficient (r) is between −1 and 1 at all times. The Pearson correlation coefficient (r) represents how close points are to a straight line. A case in which the Pearson correlation coefficient (r) has a value of −1 or 1 denotes that there is a complete linear relationship between the two variables.

FIG. 4 is a table comparatively showing performance of the existing model and the improved model with regard to non-precipitation data.

Referring to RMSEs in FIG. 4, the improved model has lower RMSEs than the existing model. Specifically, in the case of the first cluster, the RMSEs are reduced by 53.7% from 1.34 to 0.62. In the case of the second cluster, the RMSEs are reduced by 44.0% from 1.00 to 0.56.

Referring to MAEs in FIG. 4, the improved model has lower MAEs than the existing model. Specifically, in the case of the first cluster, the MAEs are reduced from 1.15 to 0.48. In the case of the second cluster, the MAEs are reduced from 0.87 to 0.43.

Referring to coefficients of determination (R²) in FIG. 4, the improved model has a higher coefficient of determination (R²) than the existing model. Specifically, in the case of the first cluster, the coefficient of determination (R²) is increased from 0.87 to 0.97. In the case of the second cluster, the coefficient of determination (R²) is increased from 0.94 to 0.98.

Referring to Pearson correlation coefficients (r) in FIG. 4, the improved model has a higher Pearson correlation coefficient (r) than the existing model. Specifically, in the case of the first cluster, the Pearson correlation coefficient (r) is increased from 0.98 to 0.99. However, in the case of the second cluster, the Pearson correlation coefficient (r) remains the same.

FIG. 5 is a table comparatively showing performance of the existing model and the improved model with regard to precipitation data.

Referring to RMSEs in FIG. 5, the RMSE are reduced by 27.8% from 0.72 of the existing model to 0.52 of the improved model. Referring to MAEs, the MAEs are reduced from 0.52 of the existing model to 0.31 of the improved model. Referring to coefficients of determination (R²), the coefficient of determination (R²) is increased from 0.97 of the existing model to 0.98 of the improved model. Finally, referring to Pearson correlation coefficients (r), the Pearson correlation coefficient (r) is increased from 0.98 of the existing model to 0.99 of the improved model.

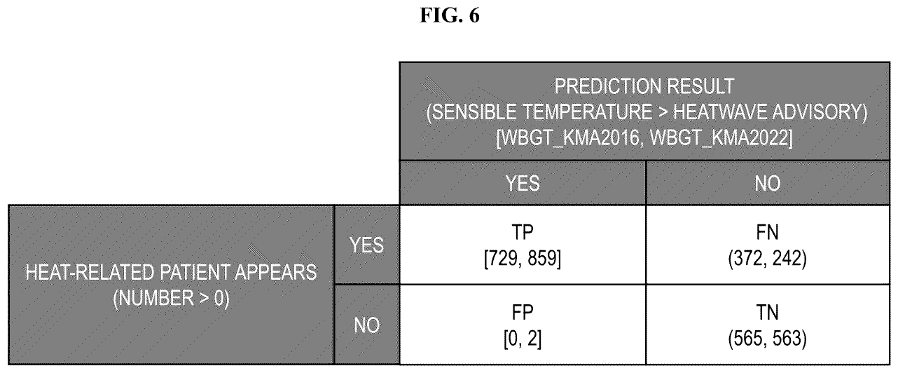

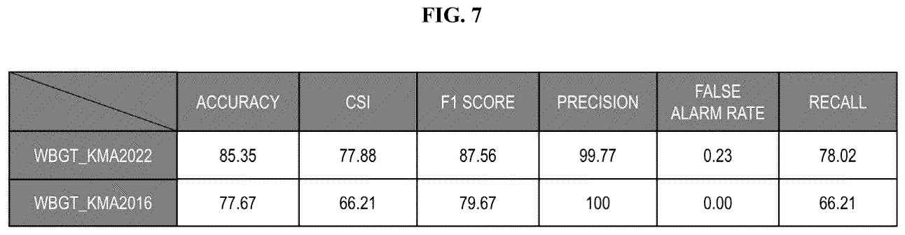

Heatwave warning simulation verification results obtained by applying the existing model and the improved model to KMA criteria for heatwave warnings will be comparatively described with reference to FIGS. 6 and 7.

For heatwave warning simulation verification of the existing model and the improved model, data about the number of patients actually diagnosed with heat-related illnesses during a certain period of time is required. In the present disclosure, data about the number of heat-related patients during the last five years (from 2017 to 2021) is used. The data about the number of heat-related patients is acquired through a system for monitoring emergency rooms for heat-related illnesses which is run by the Korea Disease Control and Prevention Agency. The system for monitoring emergency rooms for heat-related illnesses is a monitoring system for finding heat-related patients who visit emergency rooms of medical institutions in major areas nationwide.

Also, for heatwave warning simulation verification of the existing model and the improved model, the number of days a heatwave warning has actually been issued by KMA during the same period of time is required. KMA separately issues heatwave warnings as a heatwave advisory and an excessive heatwave warning. Accordingly, it may be understood that the number of days a heatwave warning has actually been issued includes at least one of the number of days a heatwave advisory has been issued and the number of days an excessive heatwave warning has been issued. A heatwave advisory is issued when it is expected that a daily maximum temperature of 33° C. or higher will last for two days or more, and an excessive heatwave warning is issued when a daily maximum temperature of 35° C. or higher will last for two days or more.

FIG. 6 is a confusion matrix showing prediction results of the existing model and prediction results of the improved model.

In FIG. 6, a day in which at least one person is diagnosed with a heat-related illness is displayed as true. On the other hand, a day in which no person is diagnosed with a heat-related illness is displayed as false. When a prediction result of a model, that is, a sensible temperature calculated through the model, is 33° C. which is the criterion for a heatwave advisory, or higher for more than two days, the days are displayed as positive. On the other hand, when a prediction result of a model, that is, a sensible temperature calculated through the model, is less than 33° C., the day is displayed as negative. Also, a prediction result of the existing model is displayed on the left side in each cell, and a prediction result of the improved model is displayed on the right side in each cell.

In FIG. 6, “true positive (TP)” represents cases in which a model predicts that there is a heatwave and a person is actually diagnosed with a heat-related illness. While the existing model shows 729 TP cases, the improved model shows 859 TP cases, which is an increase. This means that the number of heatwave warnings issued increases by 130 when the improved model is used.

In FIG. 6, “true negative (TN) represents cases in which a model predicts that there is no heatwave and no person is actually diagnosed with a heat-related illness. While the existing model shows 565 TN cases, the improved model shows 563 TN cases, which is a decrease.

In FIG. 6, “false positive (FP) represents cases in which a model predicts that there is a heatwave and no person is actually diagnosed with a heat-related illness. While the existing model shows 0 FP cases, the improved model shows 2 FP cases, which is an increase.

In FIG. 6, “false negative (FN) represents cases in which a model predicts that there is no heatwave and a person is actually diagnosed with a heat-related illness. While the existing model shows 372 FN cases, the improved model shows 242 FN cases, which is a decrease.

For each of the existing model and the improved mode, six evaluation indicators may be calculated on the basis of the confusion matrix of FIG. 6. For example, accuracy (ACC), precision, recall, a critical success index (CSI), an F1 score, and a false alarm rate may be calculated. The accuracy is an indicator for evaluating how accurately a model makes a prediction. The precision is a ratio of actually true cases to cases predicted to be true by a model. The recall is a ratio of cases predicted to be true by a model to actually true cases. The CSI is a ratio of cases predicted to be true by a model to all cases related to a specific indicator (true or false). For example, when the specific indicator is true, CSI is a ratio of cases which are predicted to be true by a model and are actually true to all cases related to truth (i.e., cases which are predicted to be false by the model but are actually true, cases which are predicted to be true by the model but are actually false, and the cases which are predicted to be true by the model and are actually true). The F1 score is a harmonic mean of the precision and the recall. Accuracy, precision, recall, a CSI, an F1 score, and a false alarm rate are represented as Equation 6 to Equation 10, respectively.

$$Accuracy = \frac{TP + TN}{TP + TN + FP + FN} \qquad [ Equation 6 ]$$

$$Precision = \frac{TP}{TP + FP} \qquad [ Equation 7 ]$$

$$Recall = \frac{TP}{TP + FN} \qquad [ Equation 8 ]$$

$$CSI = \frac{TP}{TP + FN + FP} \qquad [ Equation 9 ]$$

$$F 1 score = 2 \times ( \frac{Accuracy \times Recall}{Accuracy + Recall} ) \qquad [ Equation 10 ]$$

$$False warning rate = \frac{FP}{TP + FP} \qquad [ Equation 11 ]$$

FIG. 7 is a table comparatively showing evaluation results of an existing model and an improved model.

Referring to FIG. 7, compared to the existing model, the improved model shows a significant improvement in recall (improved by 11.81% from 66.21% to 78.02%) and a similar false alarm rate (changed from 0.00% to 0.23%). Compared to the existing model, the improved model shows accuracy improved from 77.67 to 85.35, an F1 score improved from 79.67 to 87.56, and a higher CSI.

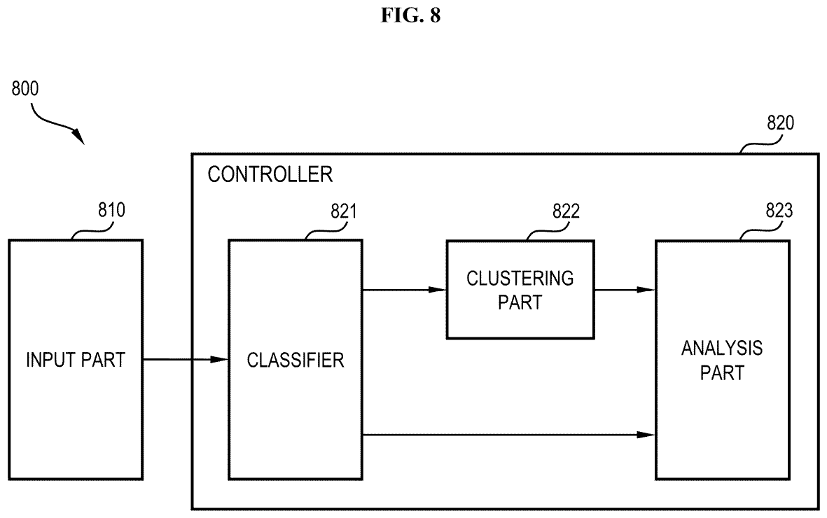

FIG. 8 is a block diagram of an apparatus for calculating a sensible temperature in consideration of outdoor ground heating according to an exemplary embodiment of the present disclosure.

Referring to FIG. 8, a sensible temperature calculation apparatus 800 includes an input part 810 and a controller 820.

The input part 810 may receive data and/or a command from a user. For example, the input part 810 may receive regression analysis data from the user. To this end, the input part 810 may include a touchscreen, a touch key, or a mechanical key.

The controller 820 performs classification and clustering on the input regression analysis data input through the input part 810. Also, the controller 820 derives a plurality of improved sensible temperature calculation formulae from the classified and clustered data and stores the plurality of improved sensible temperature calculation formulae. For these operations, the controller 820 may include a classifier 821, a clustering part 822, and an analysis part 823.

The classifier 821 classifies the regression analysis data into two groups by whether there is precipitation. In other words, the classifier 821 classifies the regression analysis data as non-precipitation data and precipitation data. The non-precipitation data is provided to the clustering part 822, and the precipitation data is provided to the analysis part 823.

The clustering part 822 clusters the non-precipitation data into K clusters using the K-means clustering algorithm. According to an exemplary embodiment, K may be equal to two. However, the number of clusters is not necessarily limited thereto and may be set to another value. The data clustered into a first cluster and a second cluster is provided to the analysis part 823. A case in which the clustering part 822 clusters non-precipitation data has been described above. However, when there is as much precipitation data as non-precipitation data, the clustering part 822 may cluster the precipitation data.

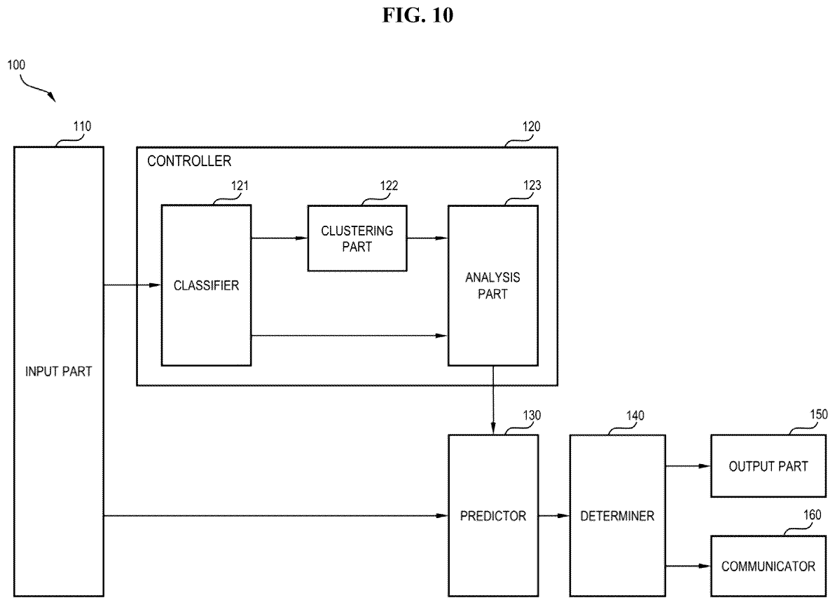

The analysis part 823 separately performs linear regression analysis on the first cluster of the non-precipitation data, the second cluster of the non-precipitation data, and the precipitation data. Although not shown in the drawing, the analysis part 823 may include a first analyzer, a second analyzer, and a third analyzer. The first analyzer derives a first sensible temperature calculation formula as shown in Equation 3 by performing linear regression analysis on the data belonging to the first cluster of the non-precipitation data. The second analyzer derives a second sensible temperature calculation formula as shown in Equation 4 by performing linear regression analysis on the data belonging to the second cluster of the non-precipitation data. The third analyzer derives a third sensible temperature calculation formula as shown in Equation 5 by performing linear regression analysis on the data belonging to the precipitation data. The derived sensible temperature calculation formulae may be stored in the sensible temperature calculation apparatus 800 or provided to another apparatus interoperating with the sensible temperature calculation apparatus 800, for example, a heatwave warning apparatus based on a sensible temperature. The heatwave warning apparatus based on a sensible temperature will be described below with reference to FIG. 10.

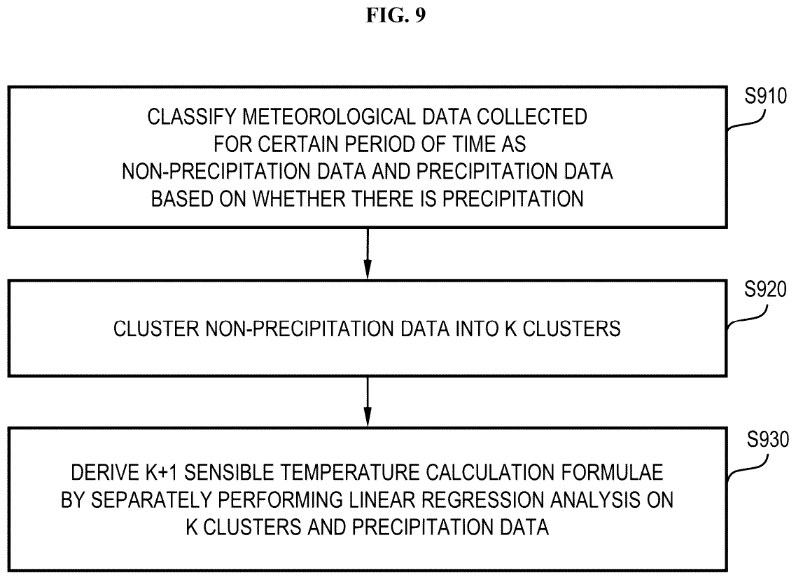

FIG. 9 is a flowchart illustrating a method of calculating a sensible temperature in consideration of outdoor ground heating according to an exemplary embodiment of the present disclosure.

First, meteorological data collected for a certain period of time is classified as non-precipitation data and precipitation data by whether there is precipitation (S910). According to an exemplary embodiment, ASOS data of Seoul Observatory from May 1, 2017, to Sep. 30, 2021, may be used.

Subsequently, the non-precipitation data is clustered into K clusters (S920). To this end, the K-means clustering algorithm may be used. The K-means clustering algorithm is an algorithm for clustering data having similar features into K clusters. According to an exemplary embodiment, the non-precipitation data may be clustered into a first cluster and a second cluster (K=2).

Subsequently, linear regression analysis is separately performed on the K clusters and the precipitation data to derive K+1 sensible temperature calculation formulae (S930). When the linear regression analysis is completed, three sensible temperature calculation formulae as shown in Equations 3 to 5 are derived.

FIG. 10 is a block diagram of a heatwave warning apparatus based on a sensible temperature according to an exemplary embodiment of the present disclosure.

Referring to FIG. 10, a heatwave warning apparatus 100 based on a sensible temperature includes an input part 110, a controller 120, a predictor 130, a determiner 140, an output part 150, and a communicator 160. Since the controller 120 shown in FIG. 10 is the same as the controller 820 shown in FIG. 8, the same description will be omitted, and differences will be mainly described.

The input part 110 receives new input data. The input data is provided to the predictor 130 which will be described below.

The predictor 130 stores sensible temperature calculation formulae provided by an analysis part 123 of the controller 120. Also, when it is necessary to predict a sensible temperature from the new input data, the predictor 130 classifies the new input data at first. Specifically, it is determined whether the new input data belongs to a non-precipitation data group or a precipitation data group, and when the new input data belongs to the non-precipitation data group, the new input data is classified into a first cluster or a second cluster. For this operation, the predictor 130 may include a classification model for data classification. Training of the classification model may be completed in advance using training data.

More specifically, the predictor 130 may classify the new input data as non-precipitation data when a precipitation value among meteorological variables related to the new input data is less than a reference value, and may classify the new input data as precipitation data when the precipitation value is the reference value or more.

When the new input data is classified as non-precipitation data, the predictor 130 separately calculates the sum (hereinafter, a “first value”) of squares of errors between the new input data and existing data belonging to the first cluster and the sum (hereinafter, a “second value”) of squares of errors between the new input data and existing data belonging to the second cluster. Subsequently, the predictor 130 classifies the new input data into a cluster related to the smaller of the first and second values.

Subsequently, the predictor 130 selects one of prestored sensible temperature calculation formulae on the basis of the classification result and predicts a sensible temperature on the basis of the selected sensible temperature calculation formula. Specifically, when the new input data is classified into the first cluster of non-precipitation data, the predictor 130 selects the first sensible temperature calculation formula of Equation 3. When the new input data is classified into the second cluster of non-precipitation data, the predictor 130 selects the second sensible temperature calculation formula of Equation 4. When the new input data is classified as precipitation data, the predictor 130 selects the third sensible temperature calculation formula of Equation 5. When a sensible temperature is predicted using the selected sensible temperature calculation formula, the predicted sensible temperature is provided to the determiner 140.

The determiner 140 compares the predicted sensible temperature with the criteria for heatwave warnings and determines whether to issue a heatwave warning on the basis of the comparison result. For example, when the predicted sensible temperature is 33° C. or higher and the sensible temperature is predicted to last for two days or more, a heatwave advisory is issued. As another example, when the predicted sensible temperature is 35° C. or higher and the sensible temperature is predicted to last for two days or more, an excessive heatwave warning is issued.

The output part 150 outputs information related to the issuance of a heatwave warning in at least one of visual, auditory, and tactile forms. The output part 150 may include at least one of a display, a sound output part, a haptic module, and a light output part. The display may constitute a layered structure with a touch sensor or may be integrated with a touch sensor, thereby implementing a touchscreen. The touchscreen may provide an input interface between the heatwave warning apparatus 100 based on a sensible temperature and a user and also provide an output interface between the heatwave warning apparatus 100 based on a sensible temperature and the user.

The communicator 160 deals with data transmission and reception between the heatwave warning apparatus 100 based on a sensible temperature and another device. For example, the communicator 160 may transmit information related to the issuance of a heatwave warning to another device through a wired or wireless network.

The components shown in FIG. 10 may be implemented as modules. The modules are software components or hardware components, such as field programmable gate arrays (FPGAs) or application-specific integrated circuits (ASICs), and perform certain roles. However, the modules are not limited to software or hardware. The modules may be configured to reside in an addressable storage medium or run one or more processors.

Accordingly, for example, the modules include components, such as software components, object-oriented software components, class components, and task components, processes, functions, attributes, procedures, subroutines, segments of program code, drivers, firmware, microcode, circuitry, data, databases, data structures, tables, arrays, and variables. Functions provided by components and modules may be combined into a smaller number of components and modules or subdivided into additional components or modules.

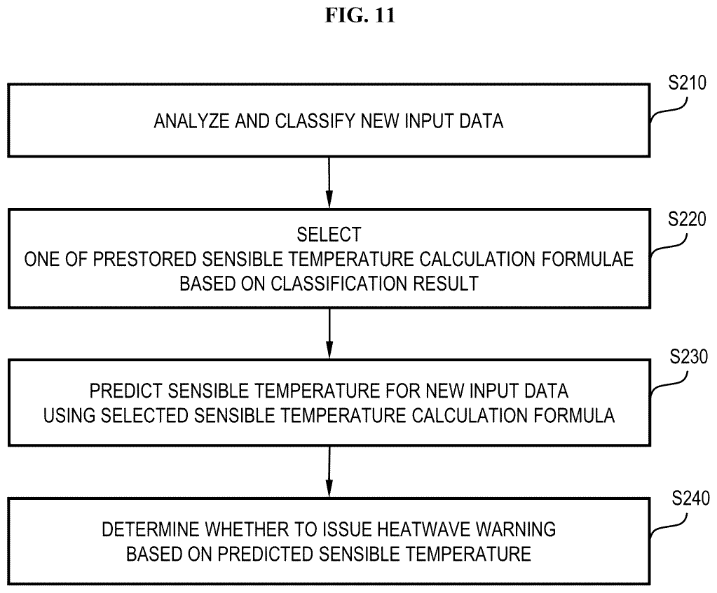

FIG. 11 is a flowchart illustrating a heatwave warning method based on a sensible temperature according to an exemplary embodiment of the present disclosure.

Prior to the description, it is assumed that a plurality of sensible temperature calculation formulae have been derived according to the method illustrated in FIG. 9.

When new input data is input in this state, the new input data is analyzed and classified (S210). Specifically, the new input data is classified into a non-precipitation data group or a precipitation data group, and when the new input data is classified into the non-precipitation data group, the new input data is classified into a first cluster or a second cluster.

For example, when a precipitation value among meteorological variables related to the new input data is less than a reference value, the new input data is classified as non-precipitation data, and when the precipitation value is the reference value or more, the new input data is classified as precipitation data.

When the new input data is classified as non-precipitation data, the sum of squares of errors is calculated between the new input data and data belonging to each existing cluster. Specifically, a “first value,” the sum of squares of errors, is calculated between the new input data and existing data belonging to the first cluster, and a “second value,” the sum of squares of errors, is calculated between the new input data and existing data belonging to the second cluster. Subsequently, the new input data is classified into a cluster related to the smaller of the first and second values. For example, when the first value is smaller than the second value, the new input data is classified into the first cluster related to the first value.

Subsequently, one of the prestored sensible temperature calculation formulae is selected on the basis of the classification result (S220). Operation S220 includes an operation of selecting the first sensible temperature calculation formula of Equation 3 when the new input data is classified into the first cluster of non-precipitation data, an operation of selecting the second sensible temperature calculation formula of Equation 4 when the new input data is classified into the second cluster of non-precipitation data, and an operation of selecting the third sensible temperature calculation formula of Equation 5 when the new input data is classified as precipitation data.

Subsequently, a sensible temperature is predicted on the basis of the selected sensible temperature calculation formula (S230).

When the sensible temperature is predicted, it is determined whether to issue a heatwave warning on the basis of the predicted sensible temperature (S240). Operation S240 includes an operation of determining to issue a heatwave advisory when the predicted sensible temperature is 33° C. or higher and the sensible temperature is predicted to last for two days or more and an operation of determining to issue an excessive heat wave warning when the predicted sensible temperature is 35° C. or higher and the sensible temperature is predicted to last for two days or more.

An apparatus and method for calculating a sensible temperature in consideration of outdoor ground heating according to exemplary embodiments of the present disclosure and a heatwave warning apparatus and method based on a sensible temperature to which the apparatus and method are applied have been described above. The disclosed embodiments may be implemented in the form of a recording medium storing computer-executable instructions. The instructions may be stored in the form of program code and may generate a program module and perform operations of the disclosed embodiments when executed by a processor. The recording medium may be implemented as a computer-readable recording medium.

The computer-readable recording medium includes any type of recording medium storing a computer-readable instruction. For example, the computer-readable recording medium may be a read-only memory (ROM), a random-access memory (RAM), a magnetic tape, a magnetic disk, a flash memory, an optical data storage device, etc.

Also, the computer-readable recording medium may be provided in the form of a non-transitory storage medium. Here, the “non-transitory storage medium” is a tangible device and may not include a signal (e.g., electromagnetic waves), and this term does not distinguish between the case in which data is semi-permanently stored in the storage medium and the case in which data is temporarily stored. For example, the “non-transitory storage medium” may include a buffer in which data is temporarily stored.

According to an embodiment, a method according to various embodiments disclosed herein may be provided to be included in a computer program product. The computer program product may be traded between a seller and a buyer as a product. The computer program product may be distributed in the form of a machine-readable storage medium (e.g., a compact disc (CD)-ROM), distributed through an application store (e.g., PlayStore™) or directly between two user devices (e.g., smartphones), or distributed (e.g., downloaded or uploaded) online. In the case of online distribution, at least a part of the computer program product (e.g., a downloadable app) may be at least temporarily stored in the machine-readable storage medium, such as the memory of a manufacturer's server, an application store's server, or a relay server, or may be temporarily generated.

According to exemplary embodiments of the present disclosure, an improved sensible temperature calculation formula reduces a systemic error compared to an existing sensible temperature calculation formula. Accordingly, the accuracy of heatwave warnings is improved, and it is possible to prevent people from not paying attention due to frequent heatwave warnings unlike the related art.

According to exemplary embodiments of the present disclosure, a ground surface temperature is reflected on an improved sensible temperature formula as a variable, and thus it is possible to provide appropriate sensible temperature information to a participant in an outdoor activity who is affected by ground heating.

Effects of the present disclosure are not limited to those described above, and other effects which have not been described will be clearly understood by those of ordinary skill in the art from the above description.

While embodiments of the present disclosure have been described above with reference to the accompanying drawings, it will be understood by those skilled in the field to which the present disclosure pertains that the present disclosure can be implemented in other specific forms without changing the technical spirit or essential characteristics thereof. Therefore, the embodiments described above should be construed as illustrative and not limiting in all aspects.

What is claimed is:

1. A method of calculating a sensible temperature in consideration of outdoor ground heating, the method comprising:
classifying data which includes a globe temperature, an atmospheric temperature, a relative humidity, and a ground surface temperature and is observed by an automated synoptic observing system (ASOS) for a certain period of time, as precipitation data and non-precipitation data according to whether there is precipitation;
clustering the non-precipitation data into K clusters; and
deriving K+1 sensible temperature calculation formulae by performing regression analysis on the K clusters and the precipitation data.

2. The method of claim 1, wherein:
a difference in a distribution of the ground surface temperature according to whether there is precipitation is greater than differences in distributions of other meteorological variables in the observed data according to whether there is precipitation, and
a difference in a distribution of a difference between the ground surface temperature and the atmospheric temperature according to whether there is precipitation is greater than the differences in distributions of the other meteorological variables according to whether there is precipitation.

3. The method of claim 1, wherein the clustering of the non-precipitation data comprises clustering the non-precipitation data into the K clusters using one of a K-means clustering algorithm, mean shift, a Gaussian mixture model (GMM), and density-based spatial clustering of application with noise (DBSCAN).

4. The method of claim 1, wherein the deriving of the K+1 sensible temperature calculation formulae comprises:
performing linear regression analysis on data belonging to a first cluster of the non-precipitation data to derive a first sensible temperature calculation formula;
performing linear regression analysis on data belonging to a second cluster of the non-precipitation data to derive a second sensible temperature calculation formula; and
performing linear regression analysis on the precipitation data to derive a third sensible temperature calculation formula.

5. The method of claim 4, wherein the first sensible temperature calculation formula is WBGT_KMA2022=WBGT_KMA2016−0.00426718(TS−TA)−0.8904166,
where WBGT_KMA2016 is a sensible temperature calculated through an existing sensible temperature calculation model,
TS−TA is a systemic error of the existing sensible temperature calculation model,
TS is a ground surface temperature, and
TA is an atmospheric temperature.

6. The method of claim 4, wherein the second sensible temperature calculation formula is WBGT_KMA2022=WBGT_KMA2016−0.1543626(TS−TA)−0.2691554,
where WBGT_KMA2016 is a sensible temperature calculated through an existing sensible temperature calculation model,
TS−TA is a systemic error of the existing sensible temperature calculation model,
TS is a ground surface temperature, and
TA is an atmospheric temperature.

7. The method of claim 4, wherein the third sensible temperature calculation formula is WBGT_KMA2022=WBGT_KMA2016−0.2052482(TS−TA)+0.3239305,
where WBGT_KMA2016 is a sensible temperature calculated through an existing sensible temperature calculation model,
TS−TA is a systemic error of the existing sensible temperature calculation model,
TS is a ground surface temperature, and
TA is an atmospheric temperature.

8. An apparatus for calculating a sensible temperature in consideration of outdoor ground heating, the apparatus comprising:
a classifier configured to classify data which includes a globe temperature, an atmospheric temperature, a relative humidity, and a ground surface temperature and is observed by an automated synoptic observing system (ASOS) for a certain period of time, as precipitation data and non-precipitation data according to whether there is precipitation;
a clustering part configured to cluster the non-precipitation data into K clusters; and
an analysis part configured to derive K+1 sensible temperature calculation formulae by performing regression analysis on the K clusters and the precipitation data.

9. The apparatus of claim 8, wherein:
a difference in a distribution of the ground surface temperature according to whether there is precipitation is greater than differences in distributions of other meteorological variables in the observed data according to whether there is precipitation, and
a difference in a distribution of a difference between the ground surface temperature and the atmospheric temperature according to whether there is precipitation is greater than the differences in distributions of the other meteorological variables according to whether there is precipitation.

10. The apparatus of claim 8, wherein the clustering part clusters the non-precipitation data into the K clusters using one of a K-means clustering algorithm, mean shift, a Gaussian mixture model (GMM), and density-based spatial clustering of application with noise (DBSCAN).

11. The apparatus of claim 8, wherein the analysis part comprises:
a first analyzer configured to perform linear regression analysis on data belonging to a first cluster of the non-precipitation data to derive a first sensible temperature calculation formula;
a second analyzer configured to perform linear regression analysis on data belonging to a second cluster of the non-precipitation data to derive a second sensible temperature calculation formula; and
a third analyzer configured to perform linear regression analysis on the precipitation data to derive a third sensible temperature calculation formula.

12. The apparatus of claim 11, wherein the first sensible temperature calculation formula is WBGT_KMA2022=WBGT_KMA2016−0.00426718(TS−TA)−0.8904166,
where WBGT_KMA2016 is a sensible temperature calculated through an existing sensible temperature calculation model,
TS−TA is a systemic error of the existing sensible temperature calculation model,
TS is a ground surface temperature, and
TA is an atmospheric temperature.

13. The apparatus of claim 11, wherein the second sensible temperature calculation formula is WBGT_KMA2022=WBGT_KMA2016−0.1543626(TS−TA)−0.2691554,
where WBGT_KMA2016 is a sensible temperature calculated through an existing sensible temperature calculation model,
TS−TA is a systemic error of the existing sensible temperature calculation model,
TS is a ground surface temperature, and
TA is an atmospheric temperature.

14. The apparatus of claim 11, wherein the third sensible temperature calculation formula is WBGT_KMA2022=WBGT_KMA2016−0.2052482(TS−TA)+0.3239305,
where WBGT_KMA2016 is a sensible temperature calculated through an existing sensible temperature calculation model,
TS−TA is a systemic error of the existing sensible temperature calculation model,
TS is a ground surface temperature, and
TA is an atmospheric temperature.

15. A heatwave warning method based on a sensible temperature in consideration of outdoor ground heating, the heatwave warning method comprising:
classifying new input data into a group and cluster;
selecting one of a plurality of prestored sensible temperature calculation formulae on the basis of the classified group and cluster;
predicting a sensible temperature for the new input data using the selected sensible temperature calculation formula; and
determining whether to issue a heatwave warning on the basis of the predicted sensible temperature,
wherein the plurality of sensible temperature calculation formulae are derived by classifying data which includes a globe temperature, an atmospheric temperature, a relative humidity, and a ground surface temperature and is observed by an automated synoptic observing system (ASOS) for a certain period of time, as precipitation data and non-precipitation data according to whether there is precipitation, clustering the non-precipitation data into K clusters, and then performing regression analysis on the K clusters and the precipitation data.

16. A heatwave warning apparatus based on a sensible temperature in consideration of outdoor ground heating, the heatwave warning apparatus comprising:
a predictor configured to classify new input data into a group and cluster, select one of a plurality of prestored sensible temperature calculation formulae on the basis of the classified group and cluster, and predict a sensible temperature for the new input data using the selected sensible temperature calculation formula; and
a determiner configured to determine whether to issue a heatwave warning on the basis of the predicted sensible temperature,
wherein the plurality of sensible temperature calculation formulae are derived by classifying data which includes a globe temperature, an atmospheric temperature, a relative humidity, and a ground surface temperature and is observed by an automated synoptic observing system (ASOS) for a certain period of time, as precipitation data and non-precipitation data according to whether there is precipitation, clustering the non-precipitation data into K clusters, and then performing regression analysis on the K clusters and the precipitation data.
